(19) United States
(12) Patent Application Publication
(10) Pub. No.: US 2022/0385730 A1
(43) Pub. Date: Dec. 1, 2022

(54) RULES ENGINE FOR CONTROLLING CONTENT ACCESS

(71) Applicant: WarnerMedia Direct, LLC, New York, NY (US)

(72) Inventors: Zheng Hua, Seattle, WA (US); James Boisseranc, Snohomish, WA (US)

(21) Appl. No.: 17/329,479

(22) Filed: May 25, 2021

(51) Int. Cl. H04L 29/08

(52) U.S. Cl. CPC H04L 67/16

(57) ABSTRACT

The disclosed technology is directed towards a rules engine that determines whether a content asset such as a movie is allowed to be downloaded to a device, such as for offline viewing. A rules engine receives information of a request to download a content asset to a device, in which the request is associated with a user identifier and a content asset identifier. The rules engine obtains a rule identifier via the asset identifier, which is used to obtain a ruleset. The rules engine obtains user download state information associated with the user identifier, and evaluates the ruleset and the download state information to determine whether to allow the download of the content asset. A ruleset can include entries such as total downloads allowed, total downloads allowed by a studio that owns the content asset, downloaded copies of the same asset allowed (e.g., to different user devices), and the like.

### TECHNICAL FIELD

The subject application relates to video media, including video and audio content in general, and more particularly to a controlling access to downloaded content and related embodiments.

### BACKGROUND

Streaming media has become a significant way in which consumers view video content, and/or listen to audio content. However, there are times when streaming media is not available and/or practical to use. For example, when on an airplane, in a hotel, in a moving vehicle and so forth there may not be any internet service, or the service may be inadequate for acceptable streaming, e.g., in terms of needed bandwidth and/or a steady connection. Even if internet service is available and adequate in a given scenario, accessing the internet service can be too deemed too expensive by users in some situations.

As a result, some streaming media services allow downloading content for offline viewing. In this way, a user planning to take a long airplane flight, for example, can download some movies and/or programs in advance that he or she wants to watch during the flight. However, to retain commercial control over content made available for download, a streaming media service may want to impose constraints on such downloads.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating an example system in which a rules engine of a content providing (e.g., streaming media) service allows or denies download of content assets, in accordance with various aspects and embodiments of the subject disclosure.

FIG. 2 is a block diagram illustrating an example group of user devices that can download content assets as allowed by a rules engine, in accordance with various aspects and embodiments of the subject disclosure.

FIG. 3 is a block diagram illustrating a rules engine evaluating user download state information against a ruleset associated with a content asset to determine whether the content asset is allowed to be downloaded, in accordance with various aspects and embodiments of the subject disclosure.

FIG. 4 is a block diagram illustrating handling of a content asset download decision of a rules engine, in accordance with various aspects and embodiments of the subject disclosure.

FIG. 5 is a flow diagram illustrating example operations of a rules engine, in accordance with various aspects and embodiments of the subject disclosure.

FIG. 6 is a flow diagram illustrating example operations of a content providing service to determine whether to download a content asset, based on rules and user download state information, in accordance with various aspects and embodiments of the subject disclosure.

FIG. 7 is a flow diagram illustrating example operations of a content providing service for downloading a content asset upon determining that user download state information meets downloading rules associated with the content asset, in accordance with various aspects and embodiments of the subject disclosure.

FIG. 8 illustrates a flow diagram illustrating example operations of a content providing service handling a content asset download request, in accordance with various aspects and embodiments of the subject disclosure.

FIG. 9 is a block diagram representing an example computing environment into which aspects of the subject matter described herein may be incorporated.

FIG. 10 depicts an example schematic block diagram of a computing environment with which the disclosed subject matter can interact/be implemented at least in part, in accordance with various aspects and implementations of the subject disclosure.

### DETAILED DESCRIPTION

Described herein is a technology in which a rules engine controls access to downloadable content based on rules (including constraints) that can be determined by parties (e.g., content rights owners and content providers, including studios such as content producers) interested in controlling access to content assets such as movies, television shows. Such parties can include, but are not limited to, a streaming media service, a studio/content producer, a country, a content rights owner and so forth. By way of example, one studio may want to limit the number of its titles that any one user can download to the user's devices to no more than fifty; further downloads should be blocked until the user goes below that total number. A streaming media service may want to limit how long a piece of downloaded content can remain on a device for viewing before being deleted or at least blocked from viewing.

To this end, a rule identifier can be associated with a content asset such as a movie. Upon an attempt to download the content asset, a rules engine is invoked to obtain rules that are current with respect to the content asset, based on the rule identifier, for downloading that content asset. The rules are evaluated against a data store containing the user's current download state information to decide whether to allow or block the content asset download.

By way of example, consider a user who wants to download a movie that is associated with an (e.g., numeric) rule identifier of 3. Based on the rule identifier value, a set of rules are accessed (and possibly) combined, such as to indicate that the movie can only have two copies downloaded to devices of the same user, the movie is owned by a studio that limits the total number of downloaded movies from that studio to ten active titles among all devices of the user, the streaming media service limits the total downloads therefrom to twenty active titles among the user's devices, and so forth. When the download request reaches the streaming media service, the rules engine obtains the rules and evaluates them against the user's current download state information. If the rules' criteria are met, the download is allowed; if not, the download request is rejected, such as with a suitable error message advising why the download request was rejected.

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this disclosure, in some embodiments, the terms “component,” “system” and the like are intended to refer to, or include, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

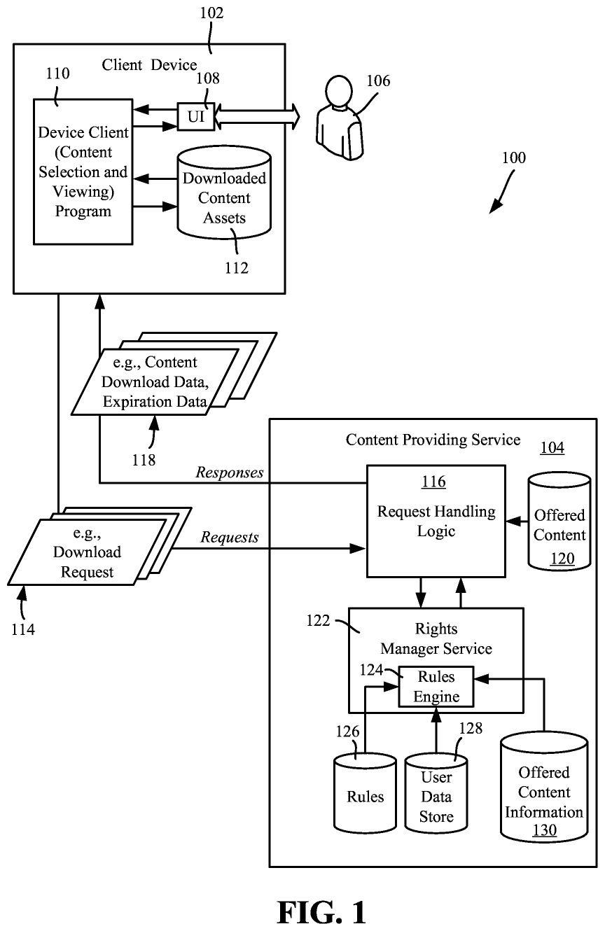

FIG. 1 is a block diagram of a system 100 showing example components and an example flow of data between a user device 102 and a content providing service 104 such as a streaming media service. In one implementation, a user 106 interacts with a user interface 108 which is part of a device client content viewing program, or more simply, a device client program 110. The device client program 110 is supplied and managed by the content providing service 104, and for example can be downloaded by a user from a mobile device store as an application, downloaded via the internet for a personal computer/laptop or smart television, installed on a television set/set-top box by a vendor, and so forth.

In general, for example, a streaming service can transmit media and other entertainment content over the Internet to an end-user. The user interface 108 associated with the streaming service device client program 110 allows the user to locate (e.g., via menus and/or search) and select a particular content asset to watch/experience from among the various content asset offerings provided by the streaming service. In addition, the user interface 108 can also provide content recommendations to the end-user, maintain a watch/experience list of content and provide parental controls to enhance the streaming experience. Further, the user can interact with the user interface 108 to download content assets for later, possible offline viewing, rather than stream the content asset. The downloaded content asset can be stored in a suitable downloaded content asset data storage 112. The downloaded content assets can be protected (e.g., encrypted) in some appropriate way such that a downloaded content asset can only be played via the device client program 110.

In one implementation, the device client program 110 sends requests 114 comprising messages and data to the content providing service 104, where request handling logic 116 (e.g., on a front end, client-facing server) determines where to route the request data for further processing so as to return appropriate responses 118. For example, a login request can be routed to authentication processing logic (not explicitly shown) to authenticate a valid user/subscriber identity based on a password or the like. Once logged in, content such as a home page can be returned in another response to a request for content, menus can be provided, a selected video content asset that is offered (e.g., from the content providing service's data store(s) 120) can be streamed or downloaded and so forth via appropriate responses 118 as described herein. Example requests can thus include a content asset download request, and if the download is allowed as described herein, the response(s) can include the content asset being downloaded. It is feasible for a single request to request that multiple content assets be downloaded at the same time.

In one example implementation, a request to download a content asset received by the request handling logic 116 is routed to a rights manager service 122 for handling. The rights manager service 122 incorporates or is coupled to a rules engine 124. As shown in the example of FIG. 1, the rules engine 124 is coupled to a rules data store 126 containing sets of rules, a user data store 128 containing per-user download state information, and offered content information 130 from which the rule associated with that content asset can be obtained.

In one example implementation, in general the request download operation flow starts when a user clicks on a download button available from the user interface 108 of the device client program 110. A video manifest response is returned from the client-facing front end service, along with a license URL that the device client program 110 needs to store and use for license acquisition. The same request download flow can be used for renewing a download (described below), although in the case of renewal, the client can skip downloading the content asset again and proceed to license acquisition.

Such license requests go through a digital rights management (DRM) proxy service that decodes the user token (returned following successful login/authentication) and calls the rights manager service 122 for verification before proxying the request to DRM servers, e.g., containing the offered content. Validation from the rights manager service 122 is needed as some time may have elapsed since the user requested the download. A verification or re-verification validates that the content asset is still being offered as available and that the license request is authentic (the user ID, profile ID, account ID and device ID from the user token match the download record). In one implementation, the rights manager service 122 uses an “available Until” timestamp to calculate the appropriate expiration settings. The DRM proxy service passes the expiration values as query parameters when calling the DRM servers.

If a license is successfully returned from the DRM servers, the DRM Proxy makes an additional call to the rights manager service 122 to mark the download record as license issued. This can be optional, but helps distinguish between having a download versus an active license. If the user is online and either deletes or cancels a download, the device client program sends an appropriate request to the content providing service 104, whereby the rights manager service 122 marks the download record for deletion and frees up the download allowance.

While offline, the user has the ability to delete downloads on his or her devices. A download can also be expired, including from the services side. On startup of the device client program 110, if the user is online, the device client program 110 sends a request with the active downloads on the device to the content providing service 104. The rights manager service 122 marks any download records that are present on the service side as expired. The response back to the client device 102 from the service 104 indicates to the device client program 110 whether each download is still active. The device client program 110 marks downloads as expired based the service's response.

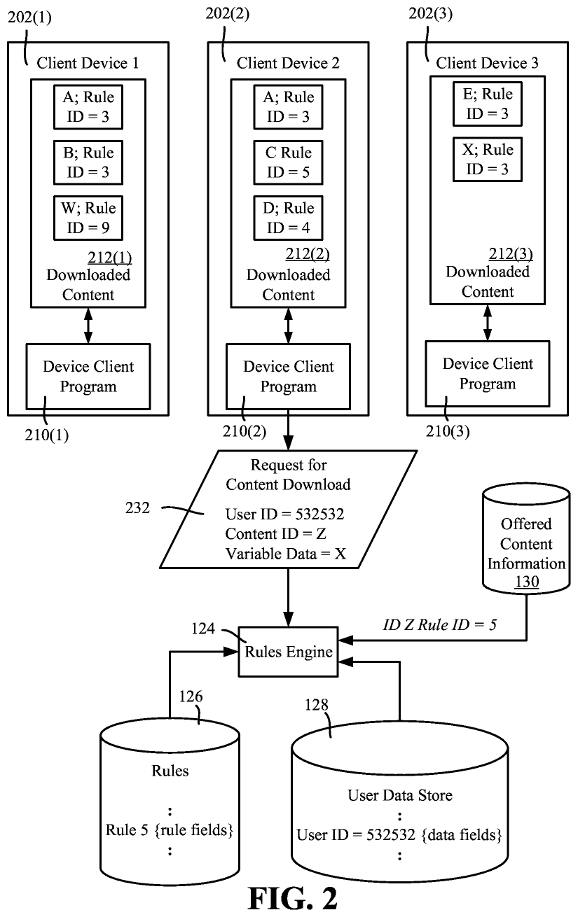

As shown in FIG. 2, a user (e.g., user account, including family members sharing the account) can have multiple client devices. Non-limiting example devices can include smart television sets, smartphones, computers (laptops, tablets, desktops), set-top boxes and the like, and so on. While three such client devices 202(1)-202(3) are depicted in FIG. 2, it is understood that a given user account can have only a single such device, while other user accounts can have more than three, up to any practical number, which can be limited to some number of active devices by the streaming media service.

The depicted client devices 202(1)-202(3) have respective instances of the device client program, labeled 210(1)-210(3) respectively, with each instance being appropriately programmed for their corresponding device. The depicted client devices 202(1)-202(3) contain downloaded content 212(1)-212(3), respectively.

As shown in FIG. 2, some of the content can be a copy of the same content (“asset”) such as a movie; for example, the content identified as “A” (which would actually be a GUID, or a unique URN or the like) has been downloaded to the downloaded content 212(1) storage container of the client device 202(1) as well as the downloaded content 212(2) storage container of the client device 202(2). The number of downloaded copies of the same asset that the same user account can have can be limited by rule as described herein.

Further, each content asset depicted in FIG. 2 is associated with a rule identifier (ID), (although as described herein, there is not necessarily any need for the rule identifiers to be maintained on the client device(s)). The rule identifiers are shown in conjunction with the assets on the client devices to emphasize that two or more different content assets can have the same rule identifier, e.g., content assets A, B, E and X are each associated with a rule ID of three (Rule ID=3).

When a user interacting with the device client program (e.g., 210(2)) selects a content asset for download, the device client program 210(2) in this example makes a request 232 for the selected content asset, shown in FIG. 2 as a content asset with an ID of Z. The request is routed to the rules engine 124, where the rules engine looks up, by accessing the offered content information data store 130 (e.g., a database), the rule ID for content asset Z, which in this example is shown as being five (rule ID=5). The rule ID can be alternatively maintained with the offered content asset, or can be looked up via another entity such as key-value store or other data store that maps asset identifiers to their respective rule identifiers.

In general, the rules comprise constraints (e.g., in records and fields in the rules data store 126) that are evaluated by the rules engine 124 against per-user data, e.g. maintained in the user data store 128. As one straightforward example, a rule constraint may limit a user account to no more than thirty total downloads. The user data store 128 maintains the current download state information for a user account, which can include the user's total downloads. If the user has not reached the limit, the requested download will be allowed (assuming other constraints, such as those exemplified herein, are also not violated).

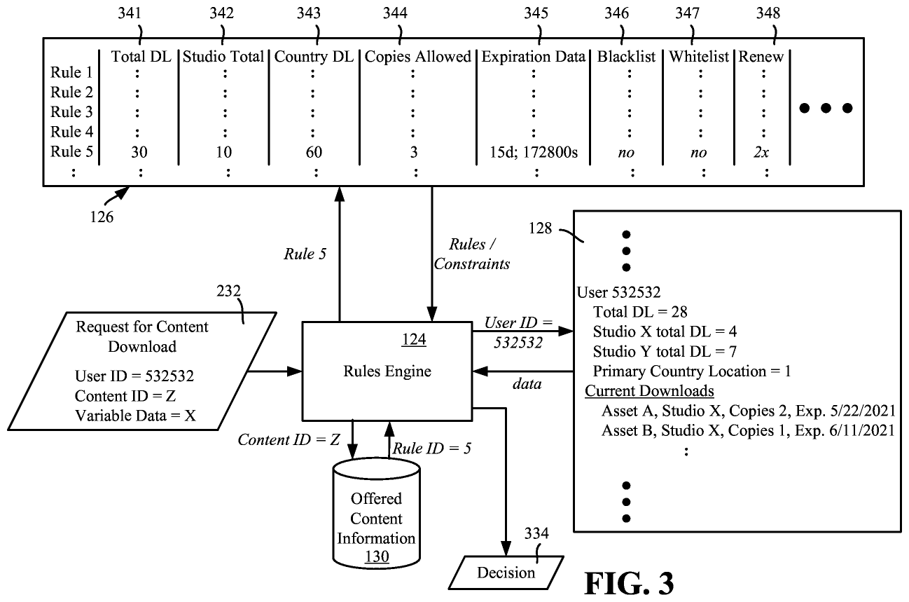

FIG. 3 shows some example non-limiting rules in the rule data store 126 that can be evaluated by the rules engine 124 against user data 128 (the user's current download state information). In the example of FIG. 3, the rule IDs correspond to records (rulesets), with fields 341-348 representing each rule's values. The rules can thus be maintained in separate fields of values or the like, but such fields are not necessarily independent from each other. Note that the fields shown are only examples, and a given implementation may not contain some of these example fields, and/or may maintain additional or different fields to those exemplified in FIG. 3. Further note that the set of fields, as well as any value in any field, can be changed by the content providing service at any time; for example, a studio/content owner/content producer (hereinafter referred to as “studio” for brevity, even if not technically a studio in a customary sense) may change its limit from ten maximum downloads to twelve, in which event any ruleset or rulesets associated with that studio can be updated. The rulesets are also extensible to add or remove a field at any time.

In the example of FIG. 3, a total download (DL) field 341 can be used to limit the number of downloads allowed to a user account, which in the example of rule 5 is 30. A per-studio download limit can be maintained as part of a ruleset in a corresponding field. For example, studio X may limit downloads of content assets of that studio to five per account, studio Y may limit its content asset downloads to ten per account, and studio Z may not have any limit. In the example of FIG. 3, the studio that produced/owns the content asset associated with the corresponding ruleset (rule ID=5) has set a limit of 10.

It should be noted that the request for content 232 can contain some variable data that can influence the rule set that is applied to make a decision. As one example, the current location of the user can be a factor in evaluating the rules; e.g., a user currently in Brazil may be allowed up to sixty total downloads, but in the United States the total limit may be thirty. As is understood, such variable data can be handled in various ways; for example, a basic rule identifier for an asset can be added to a country value to determine a final rule value to use in the evaluation, a rule array can be maintained and accessed with array indices (e.g., asset rule ID, country code) to obtain a final rule value to access the ruleset record, and so on. Alternatively, the server to which the user is connected, such as in one country, can have different rule IDs or be coupled to a data store with different values for rule evaluation, than another server in another country. In the example of FIG. 3, a country total download limit is sixty, and thus may be, but need not be evaluated by the rules engine 124 because that value is greater than the total download limit of thirty.

As another example of variable data, a given user device may have a download limit, such as a child's device being limited to two downloads (without a PIN/password override). As is understood, although not explicitly shown in FIG. 3, this per-device limit can be used to prevent a child from watching too much programming, as well as from overloading the account resulting in the parent being unable to download anything further until the child device is accessed or the downloaded content expires (in one implementation, expired assets do not contribute to the download limit). The download state information in data store 128 can track downloads per user device, and the rules engine 124 can evaluate the information against the device limit data sent as variable data in a content asset download request.

A copies allowed field 344 or the like can be used limit the number of copies that can be downloaded to a user's devices. The rules engine 124 checks the user state information tracking the number of current downloaded copies for an asset; if for example the user already had three copies of the content asset Z, the download request is rejected because the copies allowed limit of 3 for the content asset's ruleset (rule ID=5) has already been reached. The same content asset thus can be downloaded any number of times up to the copies limit, noting that if deleted from a device, the deleted copy is no longer counted as a copy in one implementation. However if the same content asset is downloaded to multiple devices (and not deleted), each downloaded copy counts as one download towards the download limit.

An expiration data field 345 can be associated with a ruleset. In this way, for example, a service that has the rights to offer a movie via steaming for one month can limit viewing of the downloaded content asset to the same “hard, available until” expiration date and time, e.g., May 31 until 11:59:59 pm, or some other duration, possibly a shorter time, such as fifteen days (15d, although this can be maintained in seconds for a finer decision time) after the download if the hard expiration date would be more than fifteen days in the future. The rules engine 124 can, for example, select the shorter of the hard expiration date or the fifteen days, or this can be done when the time data is entered into the field 345. In this way, a downloaded content asset can have a default expiration date of N (e.g., N=15) days from the time the content asset is downloaded, unless the asset's programming end date (“Available until” date) is sooner. If sooner, the downloaded content asset will have an expiration date that matches the programming end date (“Available until” date) on the content offerings catalog.

As shown in the example of FIG. 3, there can be another type of expiration data, namely how long the user has to complete viewing a content asset once viewing has started, that is, a playback duration time limit. Such a “first play expiration duration” for the Z content asset's ruleset (rule ID=5) is shown in FIG. 3 in seconds (172800s) which equates to 48 hours. That is, once the user hits play on a downloaded asset, the user has 48 hours (in this example) to view the downloaded content asset before it expires. Although shown in conjunction with the content asset expiration (from download) of 15 day in a single “Expiration Data” field 345, it is understood that these time limits can be in separate fields. Indeed, the “available until” expiration date can be maintained external to the ruleset, such as in conjunction with the catalog offering.

In general, the rules engine 124 does not necessarily evaluate this particular field 345 (or fields), but rather can return the expiration data to the device client program 210(2), e.g. as part of or in association with a license to play the content asset as described with reference to FIG. 1. The expiration rule is thus enforced by the device client program 210(2) on the client device 202(2) in the example of FIG. 2, possibly in conjunction with license evaluation. It is feasible to have one or both types of expiration data for a content asset be limited to that which a user already has started with respect to another copy of that content asset, such that a user cannot simply download another copy to a different device to avoid expiration.

To summarize, the expiration data can be returned by the rules engine 124 in a response, in conjunction with an affirmative decision to allow the download, such that the content stored on the client device has the expiration data corresponding to a license. Because the device client program 210(2) controls access to a device's downloaded content data store, the device client program 210(2) can enforce rules as well, such as to delete (or prevent playback of) downloaded content when an expiration time is reached. If a user attempts to change the date and time on a device so as to play downloaded content that has expired, the next login to the service will detect the difference and can prevent further downloads to that device until the time is correctly reset, possibly blacklisting that device (as well as possibly other devices of the user) from further downloads if the same issue occurs too many times. As with streamed content, the device client program 110 also can prevent downloaded content from being played by an underage user when the rating associated with that content exceeds a rating limit allowed by parental controls to that user profile.

Returning to FIG. 3, a blacklist field 346 (e.g., binary yes or no) can be used to block download of a content asset. If blacklisted, such a content asset can only be streamed until the value is changed. For example, a studio may not want a particular asset to be made available for download, for whatever reason, in which event the streaming service can blacklist the content asset from downloading and only allow it to be streamed until the content asset owner declares otherwise. As another example, a very popular program (movie or television show) can be prevented from being downloaded for some time, such as to help add streaming service subscribers who otherwise could watch the program offline by way of a subscriber's device and thus not subscribe. Note that in addition to, or instead, of a binary yes or no, a date can be set in the blacklist field 346, for example, such that the content asset is prevented from being downloaded before that date, but can be downloaded after that date, without having to update the field's data.

A whitelist field 347 can also be maintained. For example, the streaming service that allows downloads for offline viewing may also be a studio (content producer) of its own original content assets, or otherwise own a content asset. If so, the whitelist rule field can indicate that there is no limit (e.g., “yes” being whitelisted, “no” if not), or some very large limit can be set for its subscribers who want to download the studio's original or otherwise owned content assets. Such a content asset may not be counted in the “total downloads” allowed field, for example, or if the whitelist field is unlimited, can result in the rules engine 124 bypassing an evaluation of the total downloads allowed for this content asset.

Another field 348 can be used for renew download information. Such information indicates whether an expired download can be renewed if requested by the user. The information can comprise a value, such as a number of renewals allowed, and can also include an expiration time value, such as in seconds (can renew one time for 36,000 seconds, or ten hours), with zero or “no” indicating renewal is not allowed. Note that the renew field can apply to both the expiration date (e.g., renew after 15 days from download, assuming the hard “available until” expiration date has not yet been reached) or the time duration since playback started, e.g., renew is allowed after the 48-hour expiration was reached. This renewal option, if available, can avoid having to re-download content already stored on the user's device that is blocked from playback but not yet deleted, that is, renewal unblocks the blocking of playback due to a “soft” expiration time having been reached.

In the example of FIG. 3, based on the evaluation of the ruleset (rule ID=5) against the user's current download state information, the rules engine 124 makes a decision 334 as to whether a content asset download request (e.g., content asset Z in the request 232) is allowable. As set forth above, the decision 334 can also include the expiration data, although this can be obtained by a separate component, such as a download component that retrieves a license associated with a content asset to download.

It should be noted that in one implementation, pre-roll content does not need to be downloaded in conjunction with a downloaded content asset, nor do trickplay images (used for fast forward and rewind when streaming) need to be included with the download. However, captions and subtitles are included, and a user is able to change caption/subtitles settings while playing a content asset offline.

As one alternative extension, it is feasible to have a tentative download. For example, consider that the user has reached the total download limit, and that the download request is denied. The user can be prompted as to whether to replace a downloaded content asset (e.g., the earliest one downloaded, or one already viewed) with the newly requested content asset, in which an affirmative response from the user results in the replacement without the user needing to actively perform a delete operation. It is also feasible to have a user setting in which a replacement (e.g., replace the oldest download, oldest viewed download or based on some other replacement criterion) is automatically performed by the system.

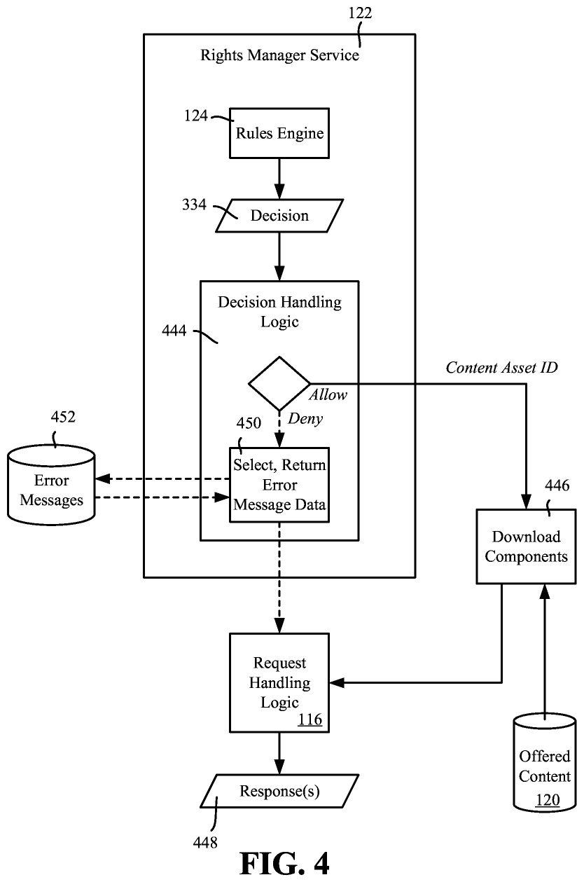

FIG. 4 shows aspects related to operations once the decision 334 is made by the rules engine 124, e.g., incorporated into or coupled to the rights manager service 122. If the download is allowed, decision handling logic 444 can invoke one or more download components 446 to download the specified content asset from the offered content 420, such as via the request handling logic 116 in one or more responses 448.

If denied, the decision handling logic 444 can, based on the reason for denial (e.g., too many total downloads, or too many total downloads from Studio X, or the like) select and return (block 450) a suitable error message from a data store 452 of such error messages via the request handling logic 116/response 448.

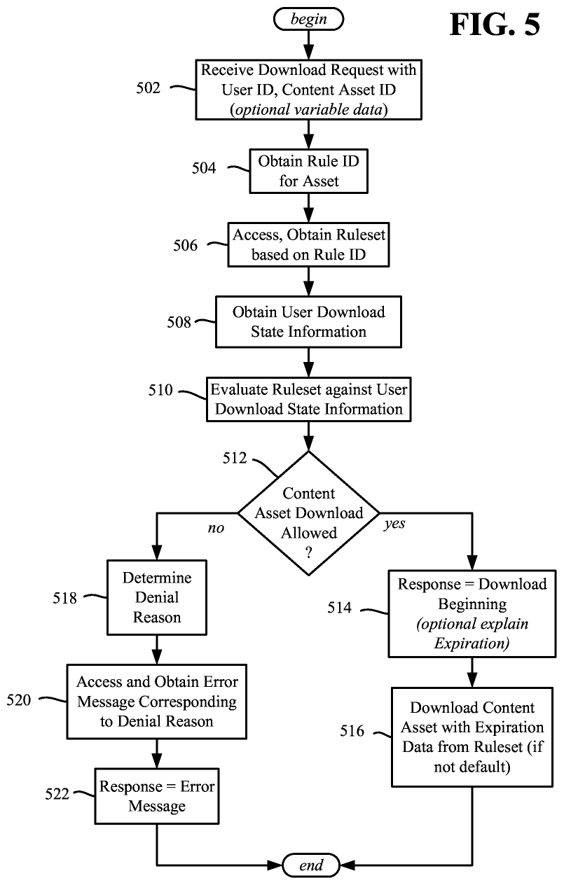

FIG. 5 summarizes example operations of an example rules engine, beginning at operation 502 where information from the download request is obtained by the rules engine. This can generally include the user ID and any other information from the token, the content asset ID of the content asset requested for download, and can also include any variable data such as country code and/or per-device limit data as set forth above.

As described above, based on the asset ID, the rule ID associated with the requested content asset is obtained at operation 504, and used at operation 506 to obtain the ruleset applicable to the content asset. Operation 508 represents obtaining (and if needed performing any processing on, such as to sum per-device downloaded assets) the user download state information. As can be readily appreciated, operation 508 can be performed in parallel or substantially in parallel with operations 504 and 506.

Operation 510 represents evaluating the ruleset against the user download state information to obtain an allow or deny decision. Operation 512 evaluates the decision, and if allowed, branches to operation 514 to begin the download response(s), which can include informing the requesting user that the download is beginning, and optionally include information regarding how long the user has to view the content offline, e.g., until June 1, but viewing needs to be completed within 48 hours of the initial start of playback. Operation 516 represents downloading the content with any expiration information that is not already in the license, for example, such as the 48-hour start window, unless known by default.

Returning to operation 512, if the download is denied, operation 518 is performed to determine the denial reason, based on the evaluation at operation 510. The reason is used to obtain and return an error message via operations 520 and 522. Note there can be more than one reason, e.g. both the total download limit and the studio limit have been reached with respect to the requested asset, in which event each reason can be explained in an error message, or one of the reasons (e.g., the most specific) can be returned as an error message.

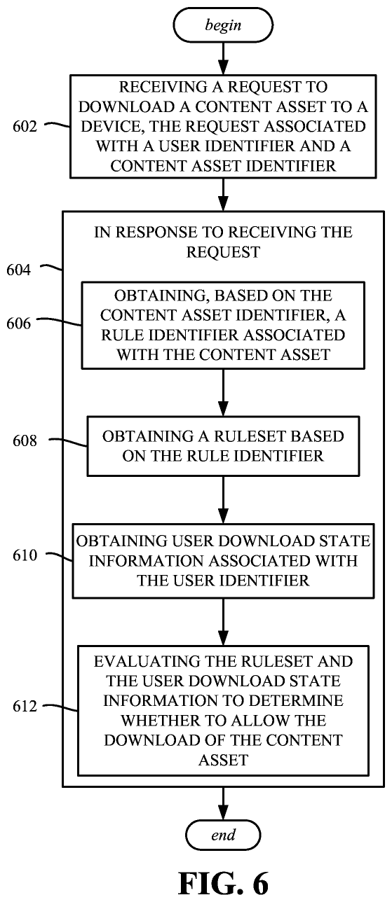

One or more aspects can be embodied in a system, such as represented in FIG. 6, and for example can comprise a memory that stores computer executable components and/or operations, and a processor that executes computer executable components and/or operations stored in the memory. Example operations can comprise operation 602, which represents receiving a request to download a content asset to a device, the request associated with a user identifier and a content asset identifier. In response to the receiving the request (operation 604), operation 606 represents obtaining, based on the content asset identifier, a rule identifier associated with the content asset, operation 608 represents obtaining a ruleset based on the rule identifier; operation 610 represents obtaining user download state information associated with the user identifier; and operation 612 represents evaluating the ruleset and the user download state information to determine whether to allow the download of the content asset.

Evaluating the ruleset can result in allowing the download of the content asset, and further operations can comprise, in response to the request, downloading the content asset to the device. Further operations can comprise, in response to the request, associating expiration data with the content asset and returning the expiration data. The expiration data can comprise an expiration end time after which the content asset can no longer be played. The expiration data can comprise a playback duration time that starts when the downloaded content asset is first played.

The ruleset can comprise a total download limit that indicates how many downloaded content assets associated with the user identifier are allowed to be active. The ruleset can comprise a studio download limit that indicates how many downloaded content assets of a studio, and associated with the user identifier, area allowed to be active. The ruleset can comprise a copy download entry that indicates how many copies of the content asset are allowed to be downloaded in association with the user identifier. The ruleset can comprise a blacklist entry that indicates whether the content asset is allowed to be downloaded. The ruleset can comprise a whitelist entry that indicates whether the content asset is counted in a total content assets downloaded count. The ruleset can comprise a renew entry that indicates whether the content asset, when expired, can be renewed for playback. The rule identifier can be based on country information.

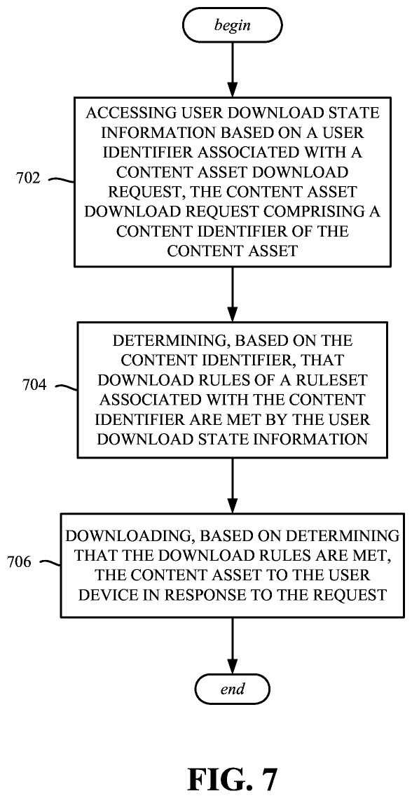

One or more aspects can be embodied in a system, such as represented in FIG. 7, and for example can comprise a memory that stores computer executable components and/or operations, and a processor that executes computer executable components and/or operations stored in the memory. Example operations can comprise operation 702, which represents accessing user download state information based on a user identifier associated with a content asset download request, the content asset download request comprising a content identifier of the content asset. Operation 704 represents determining, based on the content identifier, that download rules of a ruleset associated with the content identifier are met by the user download state information. Operation 706 represents downloading, based on determining that the download rules are met, the content asset to the user device in response to the request.

Further operations can comprise returning expiration data associated with the content asset download in response to the request.

The rules of the ruleset can correspond to entries, and the entries can comprise at least one of a total download limit entry, a studio download limit entry, a copy download entry, a blacklist entry, a whitelist entry, and/or a renew entry.

The content asset download request can comprise a device total download limit.

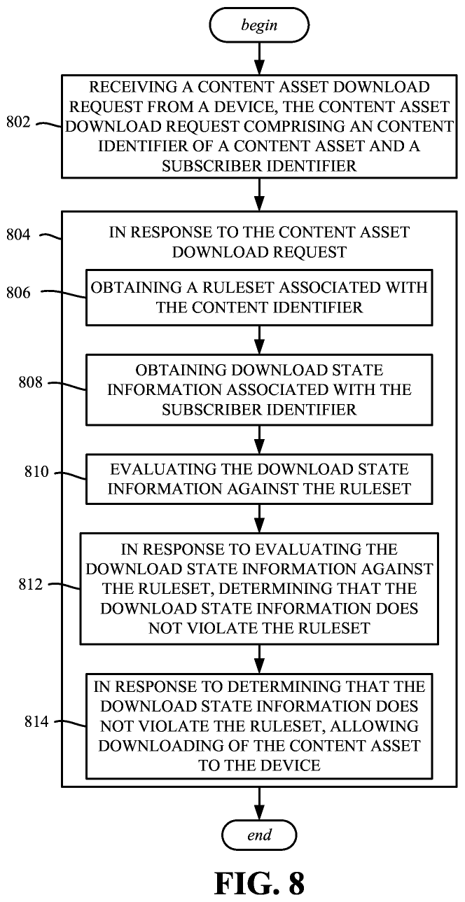

FIG. 8 summarizes various example operations, e.g., corresponding to a machine-readable storage medium, comprising executable instructions that, when executed by a processor, facilitate performance of operations. Operation 802 represents receiving a content asset download request from a device, the content asset download request comprising a content asset identifier of a content asset and a subscriber identifier. In response to the content asset download request (operation 804), operations can comprise operation 806, which represents obtaining a ruleset associated with the content identifier, operation 808, which represents obtaining download state information associated with the subscriber identifier, operation 810, which represents evaluating the download state information against the ruleset, operation 812, which represents, in response to the evaluating the download state information against the ruleset, determining that the download state information does not violate the ruleset, and operation 814, which represents, in response to the determining that the download state information does not violate the ruleset, allowing downloading of the content asset to the device.

The content asset download request can comprise a first content asset download request, the content asset can comprise a first content asset, the ruleset can comprise a first ruleset, the download state information can comprise a first instance of the download state information associated with the subscriber identifier, and further operations can comprise receiving a second content asset download request from a device, the second content asset download request comprising a second content identifier of a second content asset and the subscriber identifier, and in response to the second content asset download request, obtaining a second ruleset associated with the second content identifier, obtaining a second instance of the download state information associated with the subscriber identifier, evaluating the download state information against the second ruleset, determining that the download state information violates the second ruleset, and denying downloading of the second content asset to the device. Determining that the second instance of the download state information violates the second ruleset can comprise determining at least one of: a total download limit is reached based on the second instance of the download state information, a studio download limit is reached based on the second instance of the download state information, or a content asset copy limit is reached based on the second instance of the download state information.

Further operations can comprise returning expiration data associated with the content asset download.

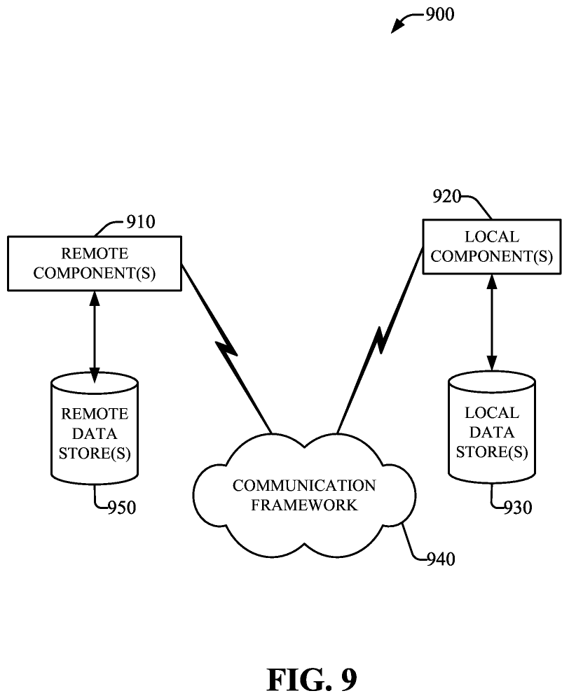

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

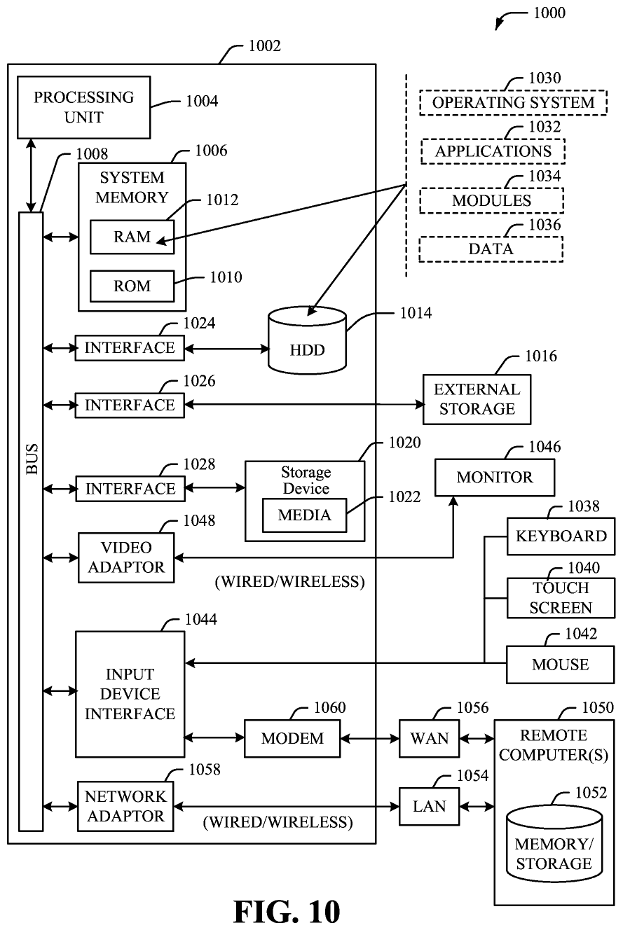

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014.

Other internal or external storage can include at least one other storage device 1020 with storage media 1022 (e.g., a solid state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device(s) 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 994 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

1. A system, comprising:
a processor; and
a memory that stores executable instructions which, when executed by the processor of the system, facilitate performance of operations, the operations comprising:
receiving a request to download a content asset to a device, the request associated with a user identifier and a content asset identifier; and
in response to the receiving the request,
obtaining, based on the content asset identifier, a rule identifier associated with the content asset,
obtaining a ruleset based on the rule identifier, wherein the ruleset comprises a rule that restricts downloading of the content in response to the content having a time-based access restriction and a determination that tampering has occurred with a timekeeping element of the device;
obtaining user download state information associated with the user identifier; and
evaluating the ruleset and the user download state information to determine whether to allow the download of the content asset.

2. The system of claim 1, wherein the evaluating the ruleset results in allowing the download of the content asset, and wherein the operations further comprise, in response to the request, downloading the content asset to the device.

3. The system of claim 2, wherein the operations further comprise, in response to the request, associating expiration data with the content asset and returning the expiration data.

4. The system of claim 3, wherein the expiration data comprises an expiration end time after which the content asset can no longer be played.

5. The system of claim 3, wherein the expiration data comprises a playback duration time that starts when the downloaded content asset is first played.

6. The system of claim 1, wherein the ruleset comprises a total download limit that indicates how many downloaded content assets associated with the user identifier are allowed to be active.

7. The system of claim 1, wherein the ruleset comprises a studio download limit that indicates how many downloaded content assets of a studio, and associated with the user identifier, area allowed to be active.

8. The system of claim 1, wherein the ruleset comprises a copy download entry that indicates how many copies of the content asset are allowed to be downloaded in association with the user identifier.

9. The system of claim 1, wherein the ruleset comprises a blacklist entry that indicates whether the content asset is allowed to be downloaded.

10. The system of claim 1, wherein the ruleset comprises a whitelist entry that indicates whether the content asset is counted in a total content assets downloaded count.

11. The system of claim 1, wherein the ruleset comprises a renew entry that indicates whether the content asset, when expired, can be renewed for playback.

12. The system of claim 1, wherein the rule identifier is based on country information.

13. A system, comprising:
a processor; and
a memory that stores executable instructions which, when executed by the processor of the system, facilitate performance of operations, the operations comprising:
accessing user download state information based on a user identifier associated with a content asset download request, the content asset download request comprising a content asset identifier of the content asset;
determining, based on the content asset identifier, that download rules of a ruleset associated with the content asset identifier are met by the user download state information, wherein the rules comprise a rule that restricts downloading of the content in response to the content having a time-based playback restriction and the user download state information indicating an alteration of a clock of the device; and
downloading, based on the determining that the download rules are met, the content asset to the user device in response to the request.

14. The system of claim 13, wherein the operations further comprise returning expiration data associated with the content asset download in a response to the content asset download request.

15. The system of claim 13, wherein the rules of the ruleset correspond to entries, the entries comprising at least one of a total download limit entry, a studio download limit entry, a copy download entry, a blacklist entry, a whitelist entry, or a renew entry.

16. The system of claim 13, wherein the content asset download request comprises a device total download limit.

17. A non-transitory machine-readable medium, comprising executable instructions that, when executed by a processor, facilitate performance of operations, the operations comprising:
receiving a content asset download request from a device, the content asset download request comprising a content asset identifier of a content asset and a subscriber identifier;
in response to the content asset download request,
obtaining a ruleset associated with the content asset identifier;
obtaining download state information associated with the subscriber identifier;
evaluating the download state information against the ruleset, wherein the ruleset comprises a rule that restricts downloading of the content asset in response to the content having a time-based download restriction and a determination that a timekeeping component of the device has been manipulated;
in response to the evaluating the download state information against the ruleset, determining that the download state information does not violate the ruleset; and
in response to the determining that the download state information does not violate the ruleset, allowing downloading of the content asset to the device.

18. The non-transitory machine-readable medium of claim 17, wherein the content asset download request is a first content asset download request, wherein the content asset is a first content asset, wherein the ruleset is a first ruleset, wherein the download state information is a first instance of the download state information associated with the subscriber identifier, and wherein the operations further comprise receiving a second content asset download request from a device, the second content asset download request comprising a second content identifier of a second content asset and the subscriber identifier, and in response to the second content asset download request, obtaining a second ruleset associated with the second content identifier, obtaining a second instance of the download state information associated with the subscriber identifier, evaluating the download state information against the second ruleset, determining that the download state information violates the second ruleset, and denying downloading of the second content asset to the device.

19. The non-transitory machine-readable medium of claim 18, wherein the determining that the second instance of the download state information violates the second ruleset comprises determining at least one of: a total download limit is reached based on the second instance of the download state information, a studio download limit is reached based on the second instance of the download state information, or a content asset copy limit is reached based on the second instance of the download state information.

20. The non-transitory machine-readable medium of claim 17, wherein the operations further comprise returning expiration data associated with the content asset download.
